(19) United States
(12) Patent Application Publication
(10) Pub. No.: US 2023/0291524 A1
(43) Pub. Date: Sep. 14, 2023

(54) METHODS AND APPARATUS FOR CHANNEL STATE MEASUREMENT AND REPORTING

(71) Applicant: LENOVO (BEIJING) LIMITED, BEIJING (CN)

(72) Inventors: HONGMEI LIU, BEIJING (CN); ZHI YAN, BEIJING (CN); YUANTAO ZHANG, BEIJING (CN); LIANHAI WU, BEIJING (CN); HAIMING WANG, BEIJING (CN)

(21) Appl. No.: 18/007,491

(22) PCT Filed: Aug. 4, 2020
(86) PCT No.: PCT/CN2020/106767

§ 371 Date: Jan. 31, 2023

(51) Int. Cl. H04L 5/00; H04W 56/00

(52) U.S. Cl. CPC H04L 5/0051; H04W 56/0015; H04W 56/0045

(57) ABSTRACT

Embodiments of the present disclosure relate to methods and apparatus for channel state measurement and reporting. According to an embodiment of the present disclosure, a method may include: transmitting, from a first node, a first signaling indicating a resource configuration of a kind of reference signal for a second node and a first identifier associated with the second node; and receiving a second signaling indicating a reporting metric associated with the reference signal and a second identifier associated with the reference signal.

### TECHNICAL FIELD

Embodiments of the present disclosure are related to wireless communication technologies, and more particularly, related to methods and apparatuses for channel state measurement and reporting, e.g., in an integrated access and backhaul (IAB) network.

### BACKGROUND

In the 3^{rd} Generation Partnership Project (3GPP), deployment of IAB nodes in a wireless communication system is promoted. One main objective for deploying IAB nodes is to enhance coverage area of a base station (BS, also called eNB in 4G networks or gNB in 5G networks) by improving throughput of a mobile device (also known as a user equipment (UE)) that locates in a coverage hole or far from the BS, which can result in a relatively low signal quality.

In a wireless communication system employing IAB nodes, a BS that can provide connections to at least one IAB node is called an IAB donor or donor node. An IAB node is connected to an IAB donor by a backhaul link. The IAB node may hop through one or more IAB nodes before reaching the IAB donor, or may be directly connected to the IAB donor.

In an IAB network, interference may occur between access and backhaul links (including across multiple hops). It is desirable to develop interference mitigation techniques including coordination of transmitting and receiving resources among IAB nodes based on channel state measurement and reporting.

### SUMMARY OF THE DISCLOSURE

Embodiments of the present disclosure at least provide a technical solution for channel state measurement and reporting.

According to an embodiment of the present disclosure, a method may include: transmitting, from a first node, a first signaling indicating a resource configuration of a kind of reference signal for a second node and a first identifier associated with the second node; and receiving a second signaling indicating a reporting metric associated with the reference signal and a second identifier associated with the reference signal.

According to another embodiment of the present disclosure, a method may include: receiving, in a first node, a first signaling indicating a resource configuration of a kind of reference signal for a second node and a first identifier associated with the second node; and transmitting a second signaling indicating a reporting metric associated with the reference signal and a second identifier associated with the reference signal.

According to another embodiment of the present disclosure, a method may include: transmitting, from a first node to a second node, a first signaling comprising information for determining a timing advance (TA) value associated with a third node based on a propagation delay associated with the third node.

According to another embodiment of the present disclosure, a method may include: receiving, in a first node, a first signaling comprising information for determining a TA value associated with a second node; and transmitting, to the second node, a second signaling indicating the TA value.

According to another embodiment of the present disclosure, a method may include: receiving, in a first node, a first signaling based on a propagation delay between a second node and a third node and a TA value for an uplink transmission performed by the third node; and determining a receiving timing for receiving the uplink transmission based on the first signaling.

According to another embodiment of the present disclosure, a method may include transmitting a first signaling to a third node based on a propagation delay between a first node and a second node.

According to yet another embodiment of the present disclosure, an apparatus may include: at least one non-transitory computer-readable medium having stored thereon computer executable instructions; at least one receiving circuitry; at least one transmitting circuitry; and at least one processor coupled to the at least one non-transitory computer-readable medium, the at least one receiving circuitry and the at least one transmitting circuitry. The computer executable instructions may cause the at least processor to implement a method according to any embodiment of the present disclosure.

Embodiments of the present disclosure can provide channel state measurement and reporting schemes to facilitate interference mitigation.

### BRIEF DESCRIPTION OF THE DRAWINGS

In order to describe the manner in which advantages and features of the present disclosure can be obtained, a description of the present disclosure is rendered by reference to specific embodiments thereof, which are illustrated in the appended drawings. These drawings depict only exemplary embodiments of the present disclosure and are not therefore intended to limit the scope of the present disclosure.

FIG. 1 illustrates an exemplary IAB system according to some other embodiments of the present disclosure;

FIG. 2 illustrates an exemplary scenario in which interference may occur between multiple IAB nodes according to some embodiments of the present disclosure;

FIG. 3 illustrates an exemplary flow chart of a method for downlink channel state measurement and reporting according to some embodiments of the present disclosure;

FIGS. 4A-4C illustrate exemplary resource configurations according to some embodiments of the present disclosure;

FIG. 5 illustrates an exemplary time domain offset configuration according to some embodiments of the present disclosure;

FIG. 6 illustrates an exemplary flow chart of another method for downlink channel state measurement and reporting according to some embodiments of the present disclosure;

FIG. 7 illustrates exemplary transmission and receiving timing at each node according to some embodiments of the present disclosure;

FIG. 8A illustrates an exemplary flow chart of a method for determining a TA value for an uplink reference signal transmission according to some embodiments of the present disclosure;

FIG. 8B illustrates an exemplary flow chart of another method for determining a TA value for an uplink reference signal transmission according to some embodiments of the present disclosure;

FIG. 9 illustrates exemplary transmission and receiving timing at each node according to some other embodiments of the present disclosure;

FIG. 10 illustrates an exemplary flow chart of a method for determining an uplink receiving timing according to some embodiments of the present disclosure; and

FIG. 11 illustrates an exemplary block diagram of an apparatus according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present disclosure, examples of which are illustrated in the accompanying drawings. To facilitate understanding, embodiments are provided under specific network architecture and new service scenarios, such as 3GPP 5G, 3GPP Long Term Evolution (LTE) and so on. Persons skilled in the art know very well that, with the development of network architecture and new service scenarios, the embodiments in the present disclosure are also applicable to similar technical problems; and moreover, the terminologies recited in the present disclosure may change, which should not affect the principle of the present disclosure.

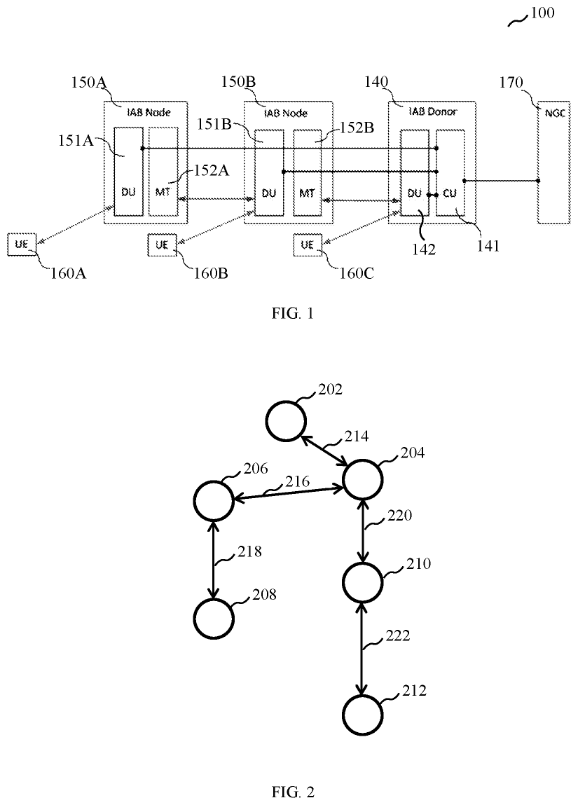

FIG. 1 illustrates an exemplary IAB system 100 according to some embodiments of the present disclosure. The IAB system 100 may include IAB donor 140, IAB node 150A, IAB node 150B, UE 160A, UE 160B, UE 160C and a Next-Generation Core (NGC) 170. Although merely, for simplicity, one IAB donor 140 is illustrated in FIG. 1, it is contemplated that the IAB system 100 may include more IAB donors in some other embodiments of the present disclosure. Similarly, although merely two IAB nodes are illustrated in FIG. 1 for simplicity, it is contemplated that IAB system 100 may include more or fewer IAB nodes in some other embodiments of the present disclosure. Although merely three UEs are illustrated in FIG. 1 for simplicity, it is contemplated that IAB system 100 may include more or fewer UEs in some other embodiments of the present disclosure.

Each of the IAB node 150A and IAB node 150B may include a distributed unit (DU) and a mobile termination (MT). In the context of this disclosure, MT is referred to as a function resided in an IAB node that terminates the radio interface layers of the backhaul Uu interface toward an IAB donor or other IAB nodes. The IAB node may be connected to an upstream IAB node (also called “parent node”) or a BS (e.g., an IAB donor) via the MT function. The IAB node may be connected to UEs or a downstream IAB node (also called “child node”) via the DU. A link between an IAB node and its parent node is called a parent link of the IAB node, and a link between an IAB node and its child node is called a child link of the IAB node.

IAB node 150A may be connected to an upstream IAB node (e.g., IAB node 150B) via MT 152A. IAB node 150A may be connected to UE 160A via DU 151A. IAB node 150A may also be connected to a downstream IAB node (not shown) via DU 151A.

IAB node 150B may be connected to an upstream IAB node or IAB donor 140 via MT 152B. IAB node 150B may be connected to UE 160B via DU 151B. IAB node 150B may be connected to a downstream IAB node (e.g., IAB node 150A) via DU 151B.

Referring to FIG. 1, the BS (e.g., IAB donor 140) may include at least one DU to support UEs and MTs of downstream IAB nodes. A centralized unit (CU) 141 included in the IAB donor 140 controls the DUs of all IAB nodes (e.g., IAB node 150A and IAB node 150B) and the DU(s) (e.g., DU 142) resided in the IAB donor 140. The DU(s) and the CU of an IAB donor may be co-located or may be located in different positions. The DU(s) and the CU of the IAB donor are connected via F1 interface. In other words, the F1 interface provides means for interconnecting the DU(s) and the CU of an IAB donor. The F1 Application Protocol (F1AP) supports the functions of F1 interface by certain F1AP signaling procedures.

In some embodiments of the present disclosure, CU 141 of the IAB donor 140 is a logical node hosting Radio Resource Control (RRC), Service Data Adaptation Protocol (SDAP) and Packet Data Convergence Protocol (PDCP) layers of the BS. The DU is a logical node hosting Radio Link Control (RLC) layer, Medium Access Control (MAC) layer and Physical layer (PHY) of a BS or an IAB node. One cell is supported by only one DU of a BS or one DU of an IAB node.

Although FIG. 1 shows that each of IAB node 150B and IAB donor 140 is connected to only one child node, it is contemplated that each IAB node can be connected to more than one child node. Similarly, although FIG. 1 shows that each of IAB node 150A and IAB node 150B is connected to only one parent node, it is contemplated that each IAB node can be connected to more than one parent node. Although FIG. 1 shows that each of IAB node 150A, IAB node 150B, and IAB donor 140 is connected to only one UE, it is contemplated that each IAB node or IAB donor can be connected to more than one UE.

According to some embodiments of the present disclosure, the UE (e.g., UE 160A, UE 160B, or UE 160C) may be a computing device, such as a desktop computer, a laptop computer, a personal digital assistant (PDA), a tablet computer, a smart television (e.g., a television connected to the Internet), a set-top box, a game console, a security system (including a security camera), a vehicle on-board computer, a network device (e.g., a router, a switch, or a modem), or the like. According to some other embodiments of the present disclosure, the UE (e.g., UE 160A, UE 160B, or UE 160C) may be a portable wireless communication device, a smart phone, a cellular telephone, a flip phone, a device having a subscriber identity module, a personal computer, a selective call receiver, or any other device that is capable of sending and receiving communication signals on a wireless network.

FIG. 2 illustrates an exemplary scenario in which interference may occur between multiple IAB nodes according to some embodiments of the present disclosure.

In the scenario illustrated in FIG. 2, an IAB node 202 is connected to its child node (i.e., an IAB node 204) via a link 214. In some embodiments of the present disclosure, the IAB node 202 may be an IAB donor. The IAB node 204 is connected to its child nodes (i.e., an IAB node 206 and IAB node 210) via a link 216 and a link 220, respectively. The IAB node 206 is connected to its child node (i.e., an IAB node 208) via a link 218. The IAB node 210 is connected to its child node (i.e., an IAB node 212) via a link 222. The IAB nodes 202, 204, 206, 208, 210, and 212 form an IAB network or part of an IAB network.

As shown in FIG. 2, the IAB node 202 may be located near to the IAB node 206 such that interference may occur between the IAB node 202 and IAB node 206. As an example, when full duplex is adopted at the IAB node 204, the IAB node 204 may transmit data or information on the link 214 and receive data or information on the link 216 simultaneously, or receive data or information on the link 214 and transmit data or information on link 216 simultaneously. Moreover, the IAB node 204 may multiplex resources between its parent link (e.g., the link 214) and its child link (e.g., the link 216 or link 220). When a transmission from the IAB node 204 to the IAB node 202 and a transmission from the IAB node 206 to the IAB node 204 use the same time-frequency resource(s), the reception at the IAB node 202 may suffer interference from the transmission at the IAB node 206 due to the close distance between the IAB node 202 and the IAB node 206. Similarly, when a transmission from the IAB node 202 to the IAB node 204 and a transmission from the IAB node 204 to the IAB node 206 use the same time-frequency resource(s), the reception at the IAB node 206 may suffer interference from the transmission at the IAB node 202 due to the close distance between the IAB node 202 and the IAB node 206. When the IAB node 202, as the parent node of IAB node 204, performs resource coordination between the parent link 214 and the child link 216 (for the IAB 206) of the IAB node 204, in order to mitigate the aforementioned interference between the IAB node 202 and the IAB node 206, the IAB node 202 should allocate resources for the parent link 214 and the child link 216 of the IAB node 204 based on a channel state between the IAB node 202 and the IAB node 206. That is, to perform interference mitigation, the IAB node 202 needs to know the channel state between the IAB node 202 and the IAB node 206.

As another example, when space division multiplexing (SDM), frequency division multiplexing (FDM), time division multiplexing (TDM) or the like is adopted between the link 214 and the link 216 and between the link 216 and the link 218, the transmission on the link 214 and the transmission on the link 218 may use the same time-frequency resource(s). When a transmission from the IAB node 204 to the IAB node 202 and a transmission from the IAB node 206 to the IAB node 208 use the same time-frequency resource(s), the reception at the IAB node 202 may suffer interference from the transmission at the IAB node 206 due to the close distance between the IAB node 202 and the IAB node 206. Similarly, when a transmission from the IAB node 202 to the IAB node 204 and a transmission from the IAB node 208 to the IAB node 206 use the same time-frequency resource(s), the reception at the IAB node 206 may suffer interference from the transmission at the IAB node 202 due to the close distance between the IAB node 202 and the IAB node 206. In such cases, in order to mitigate the aforementioned interference between the IAB node 202 and the IAB node 206, the IAB node 204 should perform resource coordination between the link 214 and the link 218 based on a channel state between the IAB node 202 and the IAB node 206. That is, to perform interference mitigation, the IAB node 204 needs to know the channel state between the IAB node 202 and the IAB node 206.

No matter the IAB nodes are stable or mobile, a channel between two IAB nodes may change dynamically. Thus, periodic, semi-static, or aperiodic channel state measurement should be performed and reported. For example, in the scenario illustrated in FIG. 2, to perform interference mitigation, the IAB node 202 or the IAB node 204 needs to be aware of the channel state measurement result performed by the IAB node 206 for the channel between the IAB node 202 and the IAB node 206. When downlink and uplink channels have reciprocity, only downlink channel state measurement and reporting is needed; otherwise, both downlink channel state measurement and reporting and uplink channel state measurement and reporting are needed.

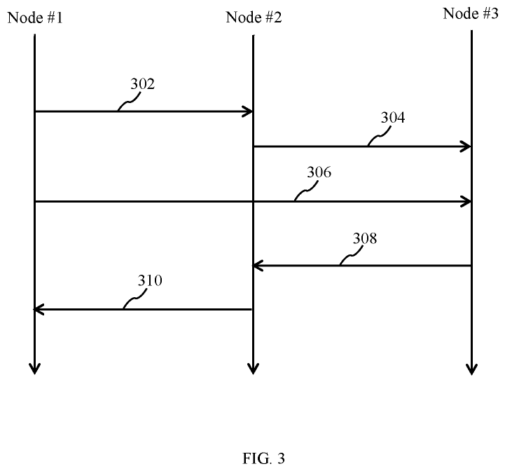

FIG. 3 illustrates an exemplary flow chart of a method for downlink channel state measurement and reporting according to some embodiments of the present disclosure.

In the example illustrated in FIG. 3, Node #1 is a parent node of Node #2, and Node #2 is a parent node of Node #3. For example, Node #1, Node #2, and Node #3 may correspond to the IAB node 202, IAB node 204, and IAB node 206 in FIG. 2, respectively. Node #1 may be an IAB donor or not. Node #1 may configure resource(s) or resource set(s) for Node #3 to perform downlink channel state measurement for the channel between Node #1 and Node #3, and Node #3 may report the measurement result to Node #1. Since Node #1 is connected to Node #3 via Node #2, the resource configuration and reporting need be forwarded or relayed by Node #2.

As shown in FIG. 3, at step 302, Node #1 (e.g., the IAB node 202) transmits a signaling (e.g., downlink control information (DCI)) indicating a resource configuration of a kind of reference signal (RS) for Node #3 (e.g., the IAB node 206) to Node #2 (e.g., the IAB node 204). The RS is a downlink RS such as a synchronization signal block (SSB), channel state information (CSI) RS, or the like.

According to some embodiments of the present disclosure, Node #1 may configure resource(s) or resource set(s) for not only Node #3 but also Node #2 or other child node of Node #2 (e.g., the IAB node 210). To identify resource(s) or resource set(s) configured for different nodes, the signaling indicating the resource configuration for a particular node may further indicate an identifier (ID) associated with the particular node. For example, the signaling transmitted at step 302 may further indicate an ID associated with Node #3.

According to some embodiments of the present disclosure, the ID is a node ID of Node #3 (e.g., IAB node 206), which is indexed among all nodes associated with the same donor node. For example, the IAB nodes 202 (when not being an IAB donor), 204, 206, 208, 210, and 212 in FIG. 2 are associated with the same IAB donor and can have node IDs of 1, 2, 3, 4, 5, and 6, respectively. According to some embodiments of the present disclosure, the ID is a node ID of Node #3 (e.g., the IAB node 206), which is indexed among all child nodes (e.g., the IAB nodes 206 and 210) of Node #2 (e.g., the IAB node 204). For example, the IAB nodes 206 and 210 can have node IDs of 1 and 2, respectively.

According to some embodiments of the present disclosure, the ID is a link ID of the link (e.g., the link 216) between Node #2 (e.g., the IAB node 204) and Node #3 (e.g., the IAB node 206), which is indexed among all links associated with the same donor node. For example, the links 214, 216, 218, 220, and 222 in FIG. 2 are associated with the same IAB donor and can have link IDs of 1, 2, 3, 4, and 5, respectively. According to some embodiments of the present disclosure, the ID is a link ID of the link (e.g., the link 216) between Node #2 (e.g., the IAB node 204) and Node #3 (e.g., the IAB node 206), which is indexed among all child links (e.g., the links 216 and 220) of Node #2. For example, the links 216 and 220 can have link IDs of 1 and 2, respectively. The node ID or link ID can be configured by the donor node of the IAB network.

After receiving the signaling from Node #1, Node #2 may determine that the resource configuration indicated by the signaling is for Node #3 based on the ID indicated by the signaling, and then transmit a signaling indicating the resource configuration to Node #3 (i.e., forward or relay the resource configuration) at step 304.

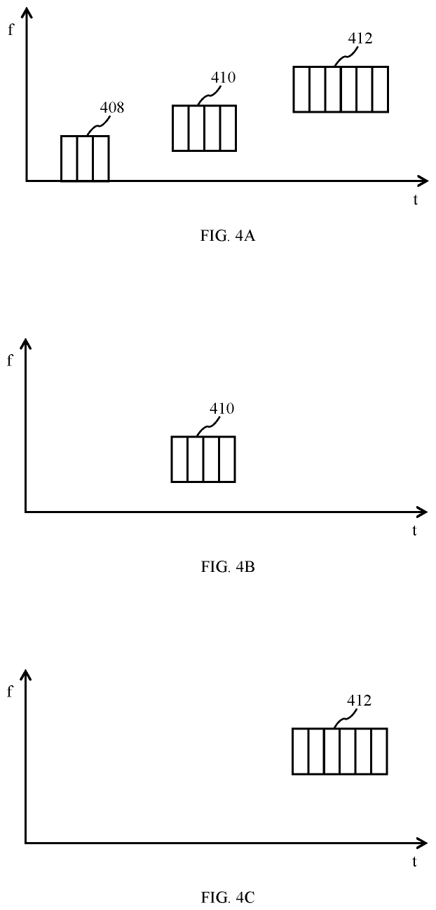

FIGS. 4A-4C illustrate exemplary but not limited resource configurations according to some embodiments of the present disclosure. Node #1 (e.g., the IAB node 202) may transmit, to Node #2 (e.g., the IAB node 204), a signaling indicating a resource set 408 for Node #2, a resource set 410 for Node #3 (e.g., the IAB node 206), and a resource set 412 for another child node of Node #2 (e.g., the IAB node 210), as shown in FIG. 4A. Then, Node #2 may transmit, to Node #3, a signaling indicating only the resource set 410 as shown in FIG. 4B, and transmit, to the another child node, e.g., the IAB node 210, a signaling indicating only the resource set 412 as shown in FIG. 4C.

For periodic and semi-persistent RS configurations, the periodicity and offset configuration for the RS relayed by Node #2 (e.g., the IAB node 204) is the same as that received from Node #1 (e.g., the IAB node 202). For aperiodic RS configuration, Node #2 needs to determine the time domain offset for its child link (e.g., the link 216 or 220) by subtracting the processing delay from the time domain offset received from Node #1. In an embodiment of the present disclosure, the time domain offset is a number of at least one slot. In another embodiment of the present disclosure, the time domain offset is a number at least one symbol. The at least one slot or at least one symbol may have a length in time domain associated with a subcarrier spacing (SC S), which is determined by an SCS of a downlink RS, an SCS of a DCI, an SCS of an active downlink bandwidth part (BWP), or an SCS of a physical downlink shared channel (PDSCH).

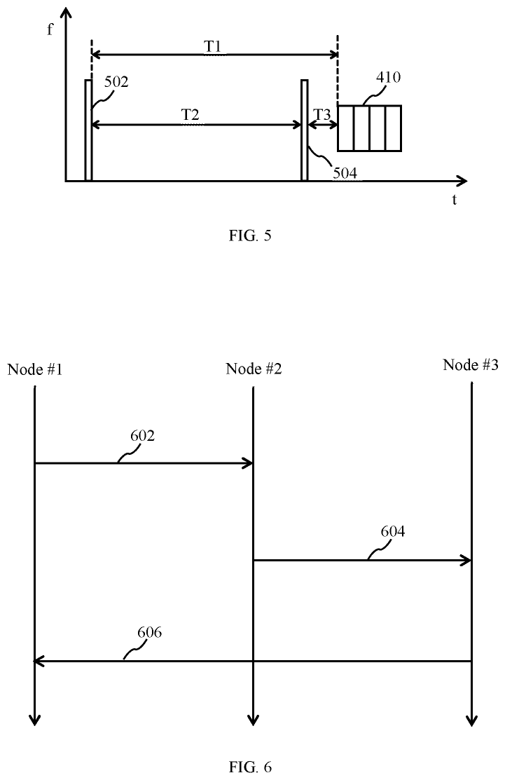

FIG. 5 illustrates an exemplary time domain offset configuration according to some embodiments of the present disclosure. DCI 502 received by Node #2 from Node #1 indicates a resource set 410 for Node #3 with a time domain offset T1. Node #2 may determine a time domain offset T3 for Node #3 by subtracting a processing delay T2 from the time domain offset T1 received from Node #1, and transmit DCI 504 indicating the time domain offset T3 to Node #3.

However, when the time domain offset T3 is indicated by DCI 504 to choose a value in a set configured via an RRC signaling, it is possible that none of the values in the RRC configured set is equal to the time domain offset T3 calculated by subtracting the processing delay T2 from the time domain offset T1, or it will make restrictions for the DCI transmission occasion at Node #2. As a result, it is desirable that Node #2 reports to Node #1 a preferred time domain offset value between the DCI (e.g., 502) transmission from Node #1 and the aperiodic RS transmission (e.g., on the resource set 410) indicated by the DCI for Node #3. Although not shown, the method illustrated in FIG. 3 may further include a step of transmitting a signaling indicating a preferred time domain offset value from Node #2 to Node #1 before step 302 in some embodiments of the present disclosure.

The preferred time domain offset value can be per child link of Node #2 or per child node of Node #2. In some embodiments of the present disclosure, Node #2 may report the node ID of Node #3 together with the preferred time domain offset value for RS transmission to Node #3. In some embodiments of the present disclosure, Node #2 may report the link ID of the link between Node #2 and Node #3 together with the preferred time domain offset value for RS transmission to Node #3. The node ID or link ID is defined the same as that described with respect to step 302 in FIG. 3. In some embodiments of the present disclosure, the reporting of the preferred time domain offset value can be performed through uplink signaling such as F1AP signaling. In some embodiments of the present disclosure, the reporting of the preferred time domain offset value can be performed through physical uplink control channel (PUCCH) or physical uplink shared channel (PUSCH).

Referring back to FIG. 3, at step 306, Node #1 transmits RS(s) (e.g., SSB or CSI-RS) using the configured resource(s) or resource set(s) to Node #3, and Node #3 may perform channel state measurement on the configured resource(s) or resource set(s). At step 308, Node #3 transmits a signaling indicating the measurement result to Node #2. At step 310, Node #2 forwards or relays the measurement result received from Node #3 to Node #1.

Node #2 may transmit not only the measurement result performed by Node #3 but also measurement result(s) performed by Node #2 or other child node of Node #2. To enable Node #1 to identify the node actually performing the measurement, the signaling transmitted from Node #2 to Node #1 and indicating the measurement result performed by a particular node may further indicate an ID associated with the particular node (e.g., a node ID or link ID as described with respect to step 302). In some embodiments, the signaling may indicate a CSI-RS resource set ID or a SSB group ID associated with the measured RS resource(s) or resource set(s), which is in turn associated with the node performing the measurement.

The measurement result may include channel status information such as a reference signal received power (RSRP), a channel quality indicator (CQI), a precoding matrix indicator (PMI), a rank indicator (RI), a layer indicator (LI), a reference signal receiving quality (RSRQ), a received signal strength indicator (RSSI), or a signal to interference plus noise ratio (SINR).

When Node #2 reports channel status information from multiple nodes, it may report an actual value of the channel status information from each node. Alternatively, it may report a differential value with respect to a reference value such that the reported data amount can be reduced. In an embodiment, the reference value is the largest or smallest value among the nodes. In another embodiment, the reference value is the value from a node with the largest or smallest index (e.g., a node ID). Other reference value(s) can be adopted without departing from the spirit and scope of the present disclosure.

An IAB node's MT part can be configured to transmit multiple reports (including but not limited to the CSI report and the time domain offset report as described with respect to FIG. 5) in the same or overlapped time domain resource(s). When the number of bits to be reported exceeds the capacity of the channel to carry the reports, the IAB node may drop report(s) with a low priority. According to some embodiments of the present disclosure, an IAB node's report on CSI measurement performed by itself is associated with a priority value determined by the following formula (1):

Pri_{iCSI}(y,k,c,s)=2·N_{cells}·Mₛ·y+N_{cells}·Mₛ·k+Mₛ·c+s (1)

### Where

y=0 for aperiodic CSI reports to be carried on PUSCH, y=1 for semi-persistent CSI reports to be carried on PUSCH, y=2 for semi-persistent CSI reports to be carried on PUCCH, and y=3 for aperiodic CSI reports to be carried on PUCCH;
k=0 for CSI reports carrying L1-RSRP and k=1 for CSI reports not carrying L1-RSRP;
c is the serving cell index and N_{cells} is the maximum number of serving cells (e.g., the value of the higher layer parameter maxNrofServingCells);
s is the report configuration ID (e.g., reportConfigID) and Mₛ is the maximum number of CSI report configurations (e.g., the value of the higher layer parameter maxNrofCSI-ReportConfigurations).

A CSI report associated with Pri_{iCSI}(y,k,c,s) having a lower value has a higher priority than that associated with Pri_{iCSI}(y,k,c,s) having a higher value.

The priority value associated with a report on CSI measurement performed by the IAB node's child node to be transmitted by the IAB node can be determined by formula (1) as well, but the serving cell index or the report configuration ID for the CSI report for the child node is different from that for the IAB node. For example, the serving cell index for the CSI report for the child node may be larger than that for the IAB node, or the report configuration ID for the CSI report for the child node may be larger than that for the IAB node. In some embodiments, the serving cell index or the report configuration ID may be determined based on the ID associated with the child node. Meanwhile, the maximum number of serving cells or the maximum number of CSI report configurations should be increased by at least one for the child node accordingly. Additionally or alternatively, the parameter k for the child node may also be determined based on the ID associated with the child node.

For simplicity, FIG. 3 merely illustrates steps of resource configuration, channel state measurement and reporting associated with Node #3. It should be understood that similar steps can be performed for resource configuration, channel state measurement and reporting associated with Node #2, and the difference only lies in that Node #2 does not need to forward or relay the resource configuration or reporting. For example, Node #1 may transmit, to Node #2, a signaling indicating a resource configuration of a kind of RS for Node #2 and an ID associated with Node #2 (e.g., a node ID of Node #2, or a link ID of the link between Node #1 and Node #2). In some embodiments, the ID associated with Node #2 is not necessary. Node #2 may perform channel state measurement on the configured resource(s) or resource set(s), and reporting the measurement result to Node #1 together with an ID associated with the RS (e.g., the ID associated with Node #2, a CSI-RS resource set ID, or a SSB group ID). In some embodiments, the ID associated with the RS is not necessary.

FIG. 6 illustrates an exemplary flow chart of another method for downlink channel state measurement and reporting according to some embodiments of the present disclosure.

Similar to FIG. 3, in the example illustrated in FIG. 6, Node #1 is a parent node of Node #2, and Node #2 is a parent node of Node #3. For example, Node #1, Node #2, and Node #3 may correspond to IAB node 202, IAB node 204, and IAB node 206 in FIG. 2, respectively. In some embodiments of the present disclosure, Node #1 may be an IAB donor. Node #1 may configure resource(s) or resource set(s) for Node #3 to transmit an uplink RS for uplink channel state measurement for the channel between Node #1 and Node #3. Since Node #1 is connected to Node #3 via Node #2, the resource configuration need be forwarded or relayed by Node #2.

As shown in FIG. 6, at step 602, Node #1 (e.g., IAB node 202) transmits a signaling indicating a resource configuration of a kind of RS for Node #3 (e.g., the IAB node 206) to Node #2 (e.g., the IAB node 204). The RS is an uplink RS such as a sounding RS (SRS) or the like. Similar to step 302, the signaling indicating a resource configuration for a particular node may further indicate an ID associated with the particular node which should perform an SRS transmission on the configured resource(s) or resource set(s). For example, the signaling transmitted at step 602 may further indicate an ID (e.g., node ID or link ID) associated with Node #3. Similarly, Node #2 may transmit a signaling indicating a preferred time domain offset value for the resource configuration to Node #1 before step 602 in some embodiments of the present disclosure.

After receiving the signaling from Node #1, Node #2 may determine that the resource configuration indicated by the signaling is for Node #3 based on the ID indicated by the signaling, and then transmit a signaling indicating the resource configuration to Node #3 (i.e., forward or relay the resource configuration) at step 604. After receiving the resource configuration, Node #3 transmits an uplink RS on the configured resource(s) or resource set(s) at step 606.

One issue to be considered for an uplink RS transmission is how to determine an uplink transmission timing advance (TA) value, which is a difference between the uplink transmission timing and the downlink receiving timing. According to some embodiments of the present disclosure, the TA value for the uplink RS transmission at Node #3 is determined such that (1) at Node #1, the uplink receiving timing from Node #3 and that from Node #1's serving UE or MT (e.g., Node #2) are aligned, or (2) at Node #3, the uplink transmission timing to Node #1 and that to Node #2 are aligned. For case (1), Node #1 or Node #2 needs to calculate the TA value for the uplink transmission from Node #3 to Node #1 and indicate the TA value to Node #3. For case (2), the TA value for the uplink transmission from Node #3 to Node #1 is the same as that for the uplink transmission from Node #3 to Node #2, which can be determined by Node #2, and Node #1 needs to determine the uplink receiving timing from Node #3.

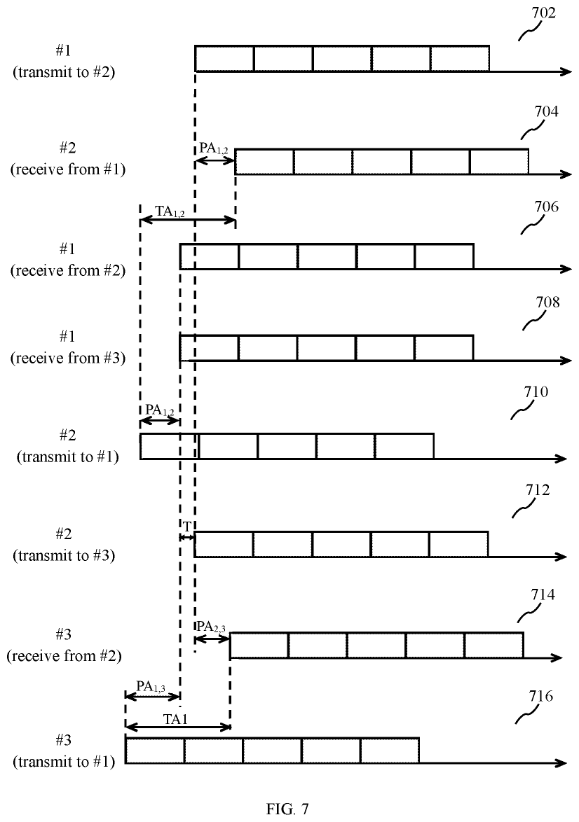

FIG. 7 illustrates exemplary transmission and receiving timing at each of Node #1, Node #2, and Node #3 in the above case (1) according to some embodiments of the present disclosure.

As shown in FIG. 7, the difference between the downlink transmission timing from Node #1 to Node #2 (702) and the downlink receiving timing at Node #2 from Node #1 (704) is a propagation delay PA_{1,2} between Node #1 and Node #2. The difference between the downlink receiving timing at Node #2 from Node #1 (704) and the uplink transmission timing from Node #2 to Node #1 (710) is a TA value TA_{1,2}. The difference between the uplink transmission timing from Node #2 to Node #1 (710) and the uplink receiving timing at Node #1 from Node #2 (706) is the propagation delay PA_{1,2} between Node #1 and Node #2. In case (1), the uplink receiving timing at Node #1 from Node #2 (706) and the uplink receiving timing at Node #1 from Node #3 (708) are aligned.

The downlink transmission timing from Node #2 to Node #3 (712) and the downlink transmission timing from Node #1 to Node #2 (702) are aligned. The difference between the downlink transmission timing from Node #2 to Node #3 (712) and the downlink receiving timing at Node #3 from Node #2 (714) is a propagation delay PA_{2,3} between Node #2 and Node #3. The difference between the downlink receiving timing at Node #3 from Node #2 (714) and the uplink transmission timing from Node #3 to Node #1 (716) is a TA value TA1. The difference between the uplink transmission timing from Node #3 to Node #1 (716) and the uplink receiving timing at Node #1 from Node #3 (708) is a propagation delay PA_{1,3} between Node #1 and Node #3. The difference between the downlink transmission timing from Node #1 to Node #2 (702) (also the downlink transmission timing from Node #2 to Node #3 (712)) and the uplink receiving timing at Node #1 from Node #2 (706) (also the uplink receiving timing at Node #1 from Node #3 (708)) is T.

It can be seen from FIG. 7 that the TA value TA1 can be calculated by the following formula (2):

TA1=PA_{1,3}+T+PA_{2,3}=PA_{1,3}+(TA_{1,2}−2*PA_{1,2})+PA_{2,3} (2)

When TA1 is calculated by Node #1 and informed to Node #2, Node #1 can determine PA_{1,3} by measurement on an uplink RS or uplink channel transmitted by Node #3. Moreover, TA_{1,2} and PA_{1,2} are known to Node #1. To calculate TA1 based on formula (2), Node #1 needs to receive an uplink reporting on PA_{2,3} from Node #2.

When TA1 is calculated by Node #2, TA_{1,2} is indicated to Node #2 by a TA command from Node #1. Moreover, PA_{1,2} and PA_{2,3} are known to Node #2. For example, Node #2 can determine PA_{1,2} based on an indication from Node #1 to set the downlink transmission timing, and determine PA_{2,3} based on a physical random access channel (PRACH) transmission from Node #3. To calculate TA1 based on formula (2), Node #2 needs to receive an indication on PA_{1,3} from Node #1, or receive an uplink reporting on PA_{1,3} from Node #3. Node #3 can determine PA_{1,3} by measurement on a downlink RS transmitted by Node #1.

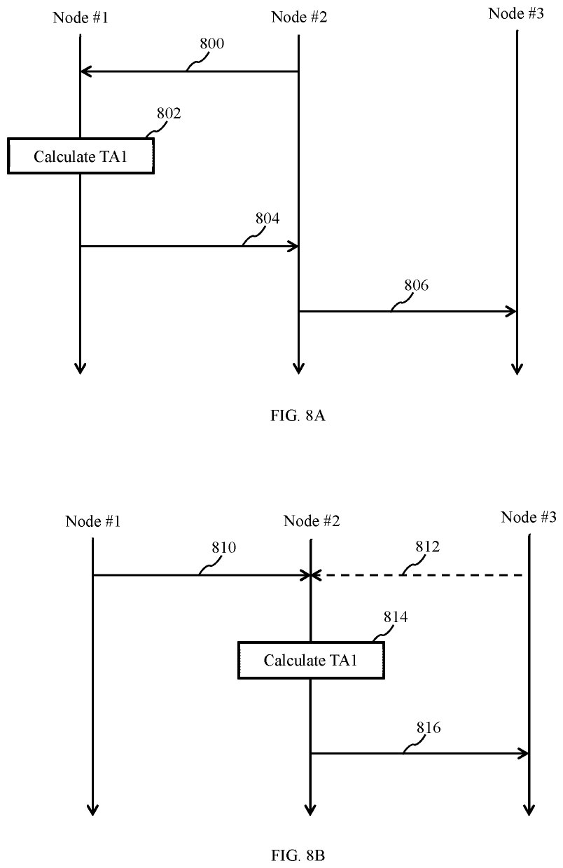

FIG. 8A illustrates an exemplary flow chart of a method for determining a TA value for an uplink RS transmission according to some embodiments of the present disclosure. Node #1, Node #2, and Node #3 in FIG. 8A may correspond to Node #1, Node #2, and Node #3 in FIG. 6, respectively.

As shown in FIG. 8A, at step 800, Node #2 transmits a signaling indicating a propagation delay (i.e., PA_{2,3}) between Node #2 and Node #3 to Node #1. At step 802, Node #1 calculates a TA value (i.e., TA1) for an uplink RS transmission of Node #3 based on, for example, formula (2). At step 804, Node #1 transmits a signaling indicating the TA value to Node #2. At step 806, Node #2 transmits a TA command indicating the TA value to Node #3. After that, Node #3 may perform the uplink RS transmission using the TA value.

FIG. 8B illustrates an exemplary flow chart of another method for determining a TA value for an uplink RS transmission according to some embodiments of the present disclosure. Node #1, Node #2, and Node #3 in FIG. 8B may correspond to Node #1, Node #2, and Node #3 in FIG. 6, respectively.

As shown in FIG. 8B, at step 810, Node #1 transmits a downlink signaling indicating a propagation delay (i.e., PA_{1,3}) between Node #1 and Node #3 to Node #2. For example, the downlink signaling may be an F1AP signaling. As an alternative to step 810 (shown as a dotted arrow), Node #3 may transmit an uplink signaling indicating the propagation delay (i.e., PA_{1,3}) between Node #1 and Node #3 to Node #2 at step 812. At step 814, Node #2 calculates a TA value (i.e., TA1) for an uplink RS transmission of Node #3 based on, for example, formula (2). At step 816, Node #2 transmits a TA command indicating the TA value to Node #3. After that, Node #3 may perform the uplink RS transmission using the TA value.

According to some embodiments of the present disclosure, the TA value configured for the uplink RS transmission received by Node #1 may be different from the TA value configured for other uplink channel(s) or other resource set(s) for uplink RS transmission(s) received by Node #2. Thus, the TA value for the uplink RS transmission received by Node #1 may be applied to a specific uplink RS resource set, and initialized (e.g., in a random access response) and updated (e.g., by a MAC control element (CE)) independent of the TA value for other uplink channel(s) or resource set(s).

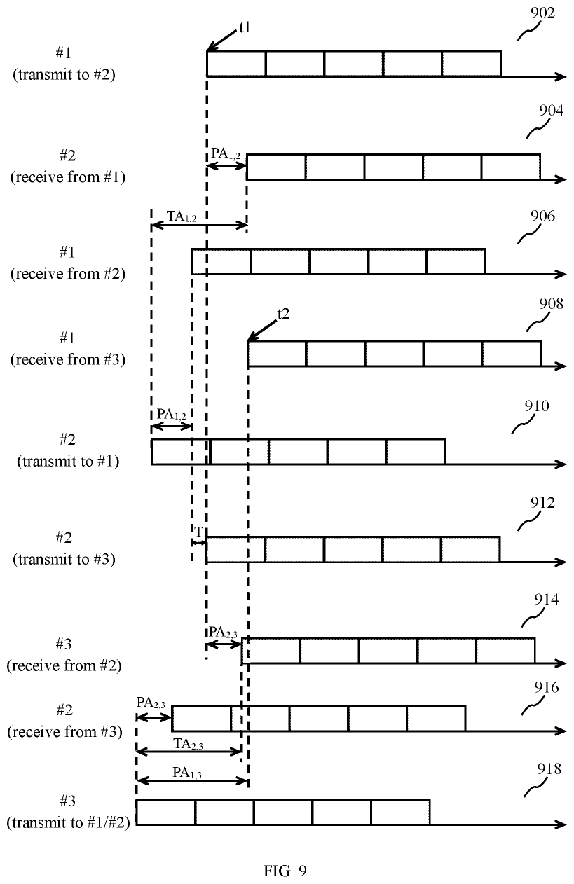

FIG. 9 illustrates exemplary transmission and receiving timing at each of Node #1, Node #2, and Node #3 in the above case (2) according to some embodiments of the present disclosure.

As shown in FIG. 9, the downlink transmission timing from Node #1 to Node #2 (902) starts at t1. The difference between the downlink transmission timing from Node #1 to Node #2 (902) and the downlink receiving timing at Node #2 from Node #1 (904) is a propagation delay PA_{1,2} between Node #1 and Node #2. The difference between the downlink receiving timing at Node #2 from Node #1 (904) and the uplink transmission timing from Node #2 to Node #1 (910) is a TA value, TA_{1,2}. The difference between the uplink transmission timing from Node #2 to Node #1 (910) and the uplink receiving timing at Node #1 from Node #2 (906) is the propagation delay PA_{1,2} between Node #1 and Node #2.

The downlink transmission timing from Node #2 to Node #3 (912) and the downlink transmission timing from Node #1 to Node #2 (902) are aligned. The difference between the downlink transmission timing from Node #2 to Node #3 (912) and the downlink receiving timing at Node #3 from Node #2 (914) is a propagation delay PA_{2,3} between Node #2 and Node #3. The difference between the downlink receiving timing at Node #3 from Node #2 (914) and the uplink transmission timing from Node #3 to Node #2 (918) is a TA value TA2,3. In case (2), the uplink transmission timing from Node #3 to Node #2 and the uplink transmission timing from Node #3 to Node #1 are aligned, so they are shown in FIG. 9 as a single timing. The difference between the uplink transmission timing from Node #3 to Node #2 (918) and the uplink receiving timing at Node #2 from Node #3 (916) is the propagation delay PA_{2,3} between Node #2 and Node #3. The difference between the uplink transmission timing from Node #3 to Node #1 (918) and the uplink receiving timing at Node #1 from Node #3 (908), which starts at t2, is a propagation delay PA_{1,3} between Node #1 and Node #3. The difference between the downlink transmission timing from Node #1 to Node #2 (902) (also the downlink transmission timing from Node #2 to Node #3 (912)) and the uplink receiving timing at Node #1 from Node #2 (906) is T.

It can be seen from FIG. 9 that the uplink receiving timing t2 can be calculated by the following formula (3):

t2=t1+PA_{2,3}−TA_{2,3}+PA_{1,3} (3)

Obviously, t1 and PA_{1,3} are known to Node #1. To calculate t2 based formula (3), Node #1 needs to know the result of PA_{2,3}−TA2,3. Both PA_{2,3} and TA2,3 are known to Node #2. Thus, Node #1 needs to receive, from Node #2, an uplink reporting on PA_{2,3} and TA2,3, or a difference between them.

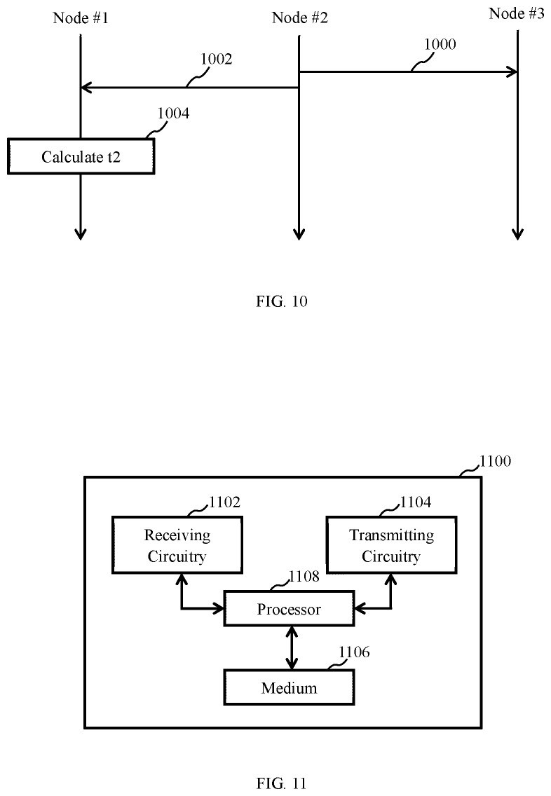

FIG. 10 illustrates an exemplary flow chart of a method for determining an uplink receiving timing (e.g., t2) according to some embodiments of the present disclosure. Node #1, Node #2, and Node #3 in FIG. 10 may correspond to Node #1, Node #2, and Node #3 in FIG. 9, respectively.

As shown in FIG. 10, at step 1000, Node #2 transmits a TA command indicating a TA value (i.e., TA_{2,3}) to Node #3. At step 1002, Node #2 transmits a signaling indicating a propagation delay between Node #2 and Node #3 (i.e., PA_{2,3}) and the TA value to Node #1. Alternatively, Node #2 may transmit a signaling indicating a time domain difference between the propagation delay between Node #2 and Node #3 (i.e., PA_{2,3}) and the TA value to Node #1. At step 1004, Node #1 calculates an uplink receiving timing (e.g., t2) based on, for example, formula (3). It should be understood that step 1000 is not necessarily performed before step 1002 or step 1004. After step 1004, Node #1 may receive an uplink RS transmission from Node #3 in accordance with the calculated uplink receiving timing.

FIG. 11 illustrates an exemplary block diagram of an apparatus 1100 according to some embodiments of the present disclosure. In some embodiments of the present disclosure, the apparatus 1100 may be any IAB node (e.g., Node #1, Node #2, or Node #3) described herein or other devices having similar functionality, which can at least perform any method illustrated in FIGS. 3, 6, 8A, 8B, and 10. In some embodiments of the present disclosure, the apparatus 1100 may be an IAB donor, which can at least perform the steps performed by Node #1 as illustrated in FIG. 3, 6, 8A, 8B, or 10.

As shown in FIG. 11, the apparatus 1100 may include at least one receiving circuitry 1102, at least one transmitting circuitry 1104, at least one non-transitory computer-readable medium 1106, and at least one processor 1108 coupled to the at least one receiving circuitry 1102, the at least one transmitting circuitry 1104, the at least one non-transitory computer-readable medium 1106. While shown to be coupled to each other via the at least one processor 1108 in the example of FIG. 11, the at least one receiving circuitry 1102, the at least one transmitting circuitry 1104, the at least one non-transitory computer-readable medium 1106, and the at least one processor 1108 may be coupled to one another in various arrangements. For example, the at least one receiving circuitry 1102, the at least one transmitting circuitry 1104, the at least one non-transitory computer-readable medium 1106, and the at least one processor 1108 may be coupled to each other via one or more local buses (not shown for simplicity).

Although in FIG. 11, elements such as receiving circuitry 1102, transmitting circuitry 1104, non-transitory computer-readable medium 1106, and processor 1108 are described in the singular, the plural is contemplated unless limitation to the singular is explicitly stated. In some embodiments of the present disclosure, the at least one receiving circuitry 1102 and the at least one transmitting circuitry 1104 are combined into a single device, such as a transceiver. In certain embodiments of the present disclosure, the apparatus 1100 may further include a memory and/or other components.

In some embodiments of the present disclosure, the at least one non-transitory computer-readable medium 1106 may have stored thereon computer-executable instructions which are programmed to cause the at least one processor 1108 to implement the steps of the methods, for example as described in view of FIGS. 3, 6, 8A, 8B, and 10, with the at least one receiving circuitry 1102 and the at least one transmitting circuitry 1104. For example, when executed, the instructions may cause the at least one processor 1108 to transmit, with the at least one transmitting circuitry 1104, a first signaling indicating a resource configuration of a kind of reference signal for a second node and a first identifier associated with the second node. The instructions may further cause the at least one processor 1108 to receive, with the at least one receiving circuitry 1102, a second signaling indicating a reporting metric associated with the reference signal and a second identifier associated with the reference signal.

As another example, when executed, the instructions may cause the at least one processor 1108 to receive, with the at least one receiving circuitry 1102, a first signaling indicating a resource configuration of a kind of reference signal for a second node and a first identifier associated with the second node. The instructions may further cause the at least one processor 1108 to transmit, with the at least one transmitting circuitry 1104, a second signaling indicating a reporting metric associated with the reference signal and a second identifier associated with the reference signal.

As another example, when executed, the instructions may cause the at least one processor 1108 to transmit to a second node, with the at least one transmitting circuitry 1104, a first signaling comprising information for determining a TA value associated with a third node based on a propagation delay associated with the third node.

As another example, when executed, the instructions may cause the at least one processor 1108 to receive, with the at least one receiving circuitry 1102, a first signaling comprising information for determining a TA value associated with a second node. The instructions may further cause the at least one processor 1108 to transmit, with the at least one transmitting circuitry 1104, a second signaling indicating the TA value to the second node.

As another example, when executed, the instructions may cause the at least one processor 1108 to receive, with the at least one receiving circuitry 1102, a first signaling based on a propagation delay between a second node and a third node and a TA value for an uplink transmission performed by the third node. The instructions may further cause the at least one processor 1108 to determining a receiving timing for receiving the uplink transmission based on the first signaling.

As another example, when executed, the instructions may cause the at least one processor 1108 to transmit, with the at least one transmitting circuitry 1104, a first signaling to a third node based on a propagation delay between the apparatus 1100 and a second node.

As will be appreciated by one skilled in the art, aspects of the embodiments may be embodied as a system, apparatus, method, or a program product. Accordingly, embodiments may take the form of an all-hardware embodiment, an all-software embodiment (including firmware, resident software, micro-code, etc.) or an embodiment combining software and hardware aspects.

For example, the disclosed embodiments may be implemented as a hardware circuit comprising custom very-large-scale integration (VLSI) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, or program code. The storage devices may be tangible, non-transitory, or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but is not limited to being, an electronic, magnetic, optical, electromagnetic, infrared, holographic, micromechanical, or semiconductor system, apparatus, or device, or any suitable combination of the foregoing.

A non-exhaustive list of more specific examples of the storage device may include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Furthermore, the described features, structures, or characteristics of the embodiments may be combined in any suitable manner. While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1.-76. (canceled)

77. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry, the apparatus operating as a first node in a network,
wherein the computer-executable instructions cause the at least one processor to:
transmit a first signaling indicating a resource configuration of a kind of reference signal for a second node and a first identifier associated with the second node; and
receive a second signaling indicating a reporting metric associated with the reference signal and a second identifier associated with the reference signal.

78. The apparatus of claim 77, wherein the reference signal is an uplink reference signal or a downlink reference signal.

79. The apparatus of claim 78, wherein the uplink reference signal is a sounding reference signal.

80. The apparatus of claim 78, wherein the downlink reference signal is a synchronization signal block or channel state information reference signal.

81. The apparatus of claim 77, wherein the first signaling is transmitted to one of the second node and a third node, which is a parent node of the second node.

82. The apparatus of claim 81, wherein the first identifier is a node identifier of the second node or a link identifier of a link between the third node and the second node.

83. The apparatus of claim 77, wherein the reporting metric comprises a time domain offset between the first signaling and a resource configured for the reference signal by the first signaling.

84. The apparatus of claim 83, wherein the time domain offset is a number of at least one slot or at least one symbol with a length in time domain associated with a subcarrier spacing (SCS).

85. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry, the apparatus operating as a first node in a network, wherein the computer-executable instructions cause the at least one processor to:
receive a first signaling indicating a resource configuration of a kind of reference signal for a second node and a first identifier associated with the second node; and
transmit a second signaling indicating a reporting metric associated with the reference signal and a second identifier associated with the reference signal.

86. The apparatus of claim 85, wherein the reference signal is an uplink reference signal or a downlink reference signal.

87. The apparatus of claim 86, wherein the uplink reference signal is a sounding reference signal.

88. The apparatus of claim 85, wherein the second node is a child node of the first node and the first identifier is a node identifier of the second node or a link identifier of a link between the first node and the second node.

89. The apparatus of claim 85, wherein the reporting metric comprises a time domain offset between the first signaling and a resource configured for the reference signal by the first signaling.

90. The apparatus of claim 89, wherein the time domain offset is a number of at least one slot or at least one symbol, the at least one slot or at least one symbol having a length in time domain associated with a subcarrier spacing (SCS).

91. The apparatus of claim 85, further comprising determining a priority for the second signaling based on at least one of a serving cell index, a report configuration identifier, or a first value associated with the second identifier.

92. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry, and the at least one transmitting circuitry, the apparatus operating as a first node in a network, wherein the computer-executable instructions cause the at least one processor to:
transmit, to a second node, a first signaling comprising information for determining a timing advance (TA) value associated with a third node based on a propagation delay associated with the third node.

93. The apparatus of claim 92, wherein the TA value is used for an uplink transmission performed by the third node of a sounding reference signal (SRS) resource or an SRS resource set.

94. The apparatus of claim 92, wherein the computer-executable instructions further cause the at least one processor to:
receive a different first signaling comprising information for determining a second timing advance (TA) value associated with a second node; and
transmit, to the second node, a second signaling indicating the TA value.

95. The apparatus of claim 94, wherein the first signaling is received from a third node, and the at least one processor transmits a propagation delay between the first node and the second node to the third node.

96. The apparatus of claim 92, wherein the computer-executable instructions further cause the at least one processor to:
receive a first signaling based on a propagation delay between the second node and a third node and a timing advance (TA) value for an uplink transmission performed by the third node; and
determine a receiving timing for receiving the uplink transmission based on the first signaling.
